(19) United States
(12) Patent Application Publication
(10) Pub. No.: US 2017/0012290 A1
(43) Pub. Date: Jan. 12, 2017

(54) NEGATIVE ELECTRODE FOR NON-AQUEOUS ELECTROLYTE SECONDARY BATTERY

(71) Applicant: SANYO ELECTRIC CO., LTD., Daito-shi, Osaka (JP)

(72) Inventors: Yasunori Watanabe, Tokushima (JP); Satoshi Yamamoto, Osaka (JP); Yasunobu Iwami, Tokushima (JP); Taizou Sunano, Osaka (JP)

(73) Assignee: Sanyo Electric Co., Ltd., Daito-shi, Osaka (JP)

(21) Appl. No.: 15/115,795

(22) PCT Filed: Jan. 27, 2015
(86) PCT No.: PCT/JP2015/000341

§ 371 Date: Aug. 1, 2016

(30) Foreign Application Priority Data
Feb. 4, 2014 (JP) 2014-019052

(51) Int. Cl. H01M 4/62; H01M 4/48; H01M 4/66; H01M 4/133; H01M 4/134; H01M 10/0587; H01M 4/36; H01M 4/587

(52) U.S. Cl. CPC H01M 4/628; H01M 4/364; H01M 4/366; H01M 4/483; H01M 4/587; H01M 4/133; H01M 4/134; H01M 10/0587; H01M 4/661; H01M 2004/027

(57) ABSTRACT

The cycle characteristics of nonaqueous electrolyte secondary batteries are improved. A negative electrode for nonaqueous electrolyte secondary batteries includes a negative electrode mixture layer on a negative electrode collector. The negative electrode mixture layer contains SiO_{X} (0.5≦X≦1.5) particles and graphite particles, and the SiO_{X} particles are covered with a cellulose-containing material. The negative electrode mixture layer contains a thickener and a binder, and the thickener contains at least one of a carboxyalkyl cellulose, a hydroxyalkyl cellulose, and an alkoxycellulose each having a degree of etherification of 0.8 or more.

### TECHNICAL FIELD

The present invention relates to a negative electrode for nonaqueous electrolyte secondary batteries.

### BACKGROUND ART

As an attempt to improve the energy density and output of lithium-ion batteries, investigations have been made into the use of negative electrode active materials such as metallic materials that can be alloyed with lithium, such as silicon, germanium, tin, and zinc, and oxides of these metals as an alternative to carbonaceous materials such as graphite.

Negative electrode active materials made from metallic materials that can be alloyed with lithium and/or oxides of these metals are known to experience a loss of cycle characteristics during charging and discharge because of the expansion and contraction of the negative electrode active materials. PTL 1 below proposes a negative electrode for nonaqueous electrolyte secondary batteries that contains a composite of a material composed of elements including Si and O and a carbon material as well as a graphitic carbon material as negative electrode active materials.

### CITATION LIST

### Patent Literature

PTL 1: International Publication No. 2013/094668

### SUMMARY OF INVENTION

### Technical Problem

The nonaqueous electrolyte secondary battery of PTL 1 is not sufficiently improved in terms of cycle characteristics.

### Solution to Problem

To solve this problem, a negative electrode according to the present invention for nonaqueous electrolyte secondary batteries includes a negative electrode collector and a negative electrode mixture layer, the negative electrode mixture layer contains SiO_{X} (0.5≦X≦1.5) particles and graphite particles, and the SiO_{X} particles are covered with a cellulose-containing material.

### Advantageous Effects of Invention

The nonaqueous electrolyte secondary battery according to the present invention, which utilizes SiO_{X} particles whose surfaces are covered with a cellulose-containing material to control nonuniform reaction at the negative electrode, is improved in terms of cycle characteristics.

### BRIEF DESCRIPTION OF DRAWINGS

FIG. 1 is a cross-sectional view of a negative electrode as an example of an embodiment of the present invention.

### DESCRIPTION OF EMBODIMENTS

The following describes an embodiment of the present invention in detail.

The drawing referenced in the description of the embodiment is a schematic, and the relative dimensions and other details of the illustrated components are not necessarily to scale. The following description should be considered when any specific relative dimensions or other details of a component are determined. Substantially 100% herein is intended to include not only 100% but also any percentage practically regarded as 100%.

A nonaqueous electrolyte secondary battery as an example of an embodiment of the present invention includes a positive electrode that contains a positive electrode active material, a negative electrode that contains a negative electrode active material, a nonaqueous electrolyte that contains a nonaqueous solvent, and a separator. An example of a nonaqueous electrolyte secondary battery is a structure in which an electrode body composed of positive and negative electrodes wound with a separator therebetween and a nonaqueous electrolyte are held together in a sheathing body.

### [Positive Electrode]

The positive electrode is preferably composed of a positive electrode collector and a positive electrode active material layer on the positive electrode collector. The positive electrode collector is, for example, a conductive thin-film body, in particular a foil of a metal or alloy that is stable in the range of positive electrode potentials, such as aluminum, or a film that has a surface layer of a metal such as aluminum. The positive electrode active material layer preferably contains a conductive material and a binder in addition to the positive electrode active material.

The positive electrode active material contains an oxide that contains lithium and one or more metallic elements M, and the one or more metallic elements M include at least one selected from a group including cobalt and nickel. Preferably, the oxide is a lithium transition metal oxide. The lithium transition metal oxide may contain non-transition metals, such as Mg and Al. Specific examples include lithium transition metal oxides such as lithium cobalt oxide, Ni—Co—Mn, Ni—Mn—Al, and Ni—Co—Al. The positive electrode active material can be one of these, and can also be a mixture of two or more.

### [Negative Electrode]

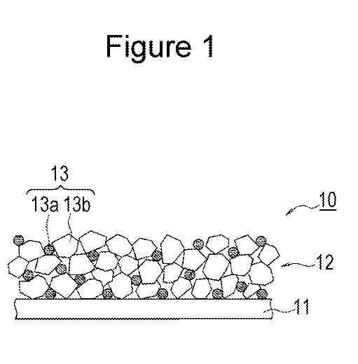

As illustrated in FIG. 1, the negative electrode 10 preferably includes a negative electrode collector 11 and a negative electrode mixture layer 12 on the negative electrode collector 11. The negative electrode collector 11 is, for example, a conductive thin-film body, in particular a foil of a metal or alloy that is stable in the range of negative electrode potentials, such as copper, or a film that has a surface layer of a metal such as copper. The negative electrode mixture layer contains a negative electrode active material, preferably with a thickener and a binder. The thickener is preferably a material such as a carboxyalkyl cellulose, a hydroxyalkyl cellulose, or an alkoxycellulose, e.g., carboxymethyl cellulose. The binder is preferably a material such as styrene-butadiene rubber (SBR) or polyimide.

The negative electrode active material 13 includes a negative electrode active material 13a that is SiO_{X} (preferably 0.5≦X≦1.5) particles and a negative electrode active material 13b that is graphite-containing particles.

The negative electrode active material 13a is preferably covered with a cellulose-containing material. Having its surface covered with a cellulose-containing material makes the negative electrode active material 13a less reactive with the electrolytic solution, thereby limiting the deterioration of the active material. The state in which SiO_{X} particles have their surfaces covered with a cellulose-containing material includes the cases in which the cellulose-containing material is adsorbed on the surfaces of the SiO_{X} particles. In the production of a negative electrode by using SiO_{X} particles with surfaces covered with a cellulose-containing material, mixing these particles with other materials such as solvent does not terminate the state in which the cellulose-containing material covers the surfaces of the SiO_{X} particles.

The cellulose-containing material is preferably a water-soluble cellulose derivative based on the C₆H₁₀O₅ structural unit, preferably a carboxyalkyl cellulose, a hydroxyalkyl cellulose, or an alkoxycellulose. Examples include carboxymethyl cellulose, methyl cellulose, hydroxyethyl cellulose, and hydroxypropyl cellulose. Carboxymethyl cellulose is particularly preferred.

The material covering the SiO_{X} particles is not limited to cellulose-containing materials and can be any polymeric material that is permeable to ions and does not react with lithium. Polymeric materials that do not react with lithium include derivatives of starch, which is based on the C₆H₁₀O₅ structural unit, such as starch acetate, starch phosphate, carboxymethyl starch, and hydroxyethyl starch and other hydroxyalkyl starches, viscous polysaccharides based on the C₆H₁₀O₅ structural unit such as pullulan and dextrin, water-soluble acrylic resin, water-soluble epoxy resin, water-soluble polyester resin, water-soluble polyamide resin, vinylidene fluoride/hexafluoropropylene copolymers, and polyvinylidene fluoride.

The proportion of the cellulose-containing material to the SiO_{X} particles is preferably from 0.2% to 0.8% by mass, more preferably from 0.4% to 0.7% by mass. When this mass ratio is too small, the cycle characteristics tend to be affected because the reactivity with the electrolytic solution is often high in such cases. When this mass ratio is too large, the cycle characteristics tend to be affected because of increased resistance of the negative electrode mixture layer.

The SiO_{X} particles are preferably covered 50% or more and 100% or less, preferably 80% or more and 100% or less, more preferably substantially 100%, with the cellulose-containing material. When the coverage is too small, the SiO_{X} particles tend to readily deteriorate. Having the surfaces of SiO_{X} particles covered with a cellulose-containing material means that the surfaces of the SiO_{X} particles are covered with coatings of the cellulose-containing material with a thickness of at least 50 nm when cross-sections of the particles are observed using SEM.

Examples of methods that can be used to cover the SiO_{X} particles with the cellulose-containing material include spray-drying and stir-drying.

The SiO_{X} particles preferably have their surfaces 50% or more and 100% or less, preferably 100%, covered with carbon. Having the surfaces of SiO_{X} surfaces covered with carbon means that the surfaces of the SiO_{X} particles are covered with carbon coatings with a thickness of at least 1 nm when cross-sections of the particles are observed using SEM. In the present invention, having SiO_{X} surfaces 100% covered with carbon means that substantially 100% of the surfaces of the SiO_{X} particles are covered with carbon coatings with a thickness of at least 1 nm when cross-sections of the particles are observed using SEM. The thickness of the carbon coatings is preferably from 1 to 200 nm, more preferably from 5 to 100 nm. Too thin carbon coatings lead to low conductivity, and too thick carbon coatings tend to affect the capacity by inhibiting the diffusion of Li⁺ into SiO_{X}.

It is preferred that carbon coatings on the surfaces of the SiO_{X} particles be covered with the cellulose-containing material. The cellulose-containing material may also cover those surfaces of the SiO_{X} particles that have no carbon coatings.

The carbon coatings are preferably formed from amorphous carbon. The use of amorphous carbon enables the formation of good and uniform coatings on the surface of SiO_{X}, thereby further promoting the diffusion of Li⁺ into SiO_{X}.

The amorphous carbon coatings are produced by, for example, immersing the SiO_{X} particles as the substrate in a solution of a material such as coal tar and processing the particles at high temperatures in an inert atmosphere. It is preferred that the heating temperature be approximately from 900° C. to 1100° C.

The negative electrode active material 13b may have its surface covered with the cellulose-containing material.

The average particle diameter of the negative electrode active material particles 13a is preferably from 1 to 15 μm, more preferably 4 to 10 μm. Too small particle diameters of the negative electrode active material particles 13a, which mean large surface areas of the particles and therefore lead to increased reaction with the electrolyte, tend to affect the capacity. Too large particle diameters, which prevent Li⁺ from diffusing into the near center of the particles, tend to affect the capacity and load characteristics.

The average particle diameter of the negative electrode active material particles 13b is preferably from 15 to 25 μm.

The ratio by mass of the negative electrode active material particles 13a to the negative electrode active material particles 13b is preferably from 1:99 to 50:50, more preferably 3:97 to 20:80. Any mass ratio in these ranges helps combine a high capacity with improved charge and discharge characteristics in the first cycle.

The thickener is preferably a carboxyalkyl cellulose, hydroxyalkyl cellulose, or alkoxycellulose having a degree of etherification of 0.8 or more. With any degree of etherification of 0.8 or more, the carboxyalkyl cellulose, hydroxyalkyl cellulose, or alkoxycellulose is readily adsorbed onto the cellulose-coated SiO_{X}. The resulting improved adhesion and electrode plate flexibility help reduce the destruction of the electrode plate structure associated with charging and discharge. Preferably, the degree of etherification is 1.0 or more and 2.0 or less, more preferably 1.2 or more and 1.8 or less. A degree of etherification more than 2.0 causes the cellulose to readily aggregate. The resulting uneven distribution of cellulose in the negative electrode mixture layer tends to affect the adhesion between the negative electrode collector 11 and the negative electrode mixture layer 12.

The mass of the thickener in the negative electrode mixture layer is preferably greater than that of the binder. The ratio by mass of the thickener to the binder is preferably from 98:2 to less than 50:50, more preferably from 80:20 to 60:40. When the thickener is less than the mass of the binder, increased resistance of the electrode plate tends to affect the cycle characteristics.

### [Nonaqueous Electrolyte]

The electrolytic salt for the nonaqueous electrolyte can be, for example, LiClO₄, LiBF₄, LiPF₆, LiAlCl₄, LiSbF₆, LiSCN, LiCF₃SO₃, LiCF₃CO₂, LiAsF₆, LiB₁₀Cl₁₀, a lower aliphatic carboxylic acid lithium salt, LiCl, LiBr, Lii, chloroborane lithium, a boric acid salt, or an imide salt. LiPF₆ is particularly preferred because of its ionic conductivity and electrochemical stability. Electrolytic salts can be used alone, and a combination of two or more electrolytic salts can also be used. These electrolytic salts are preferably contained in a proportion of 0.8 to 1.5 mol per L of the nonaqueous electrolyte.

The solvent for the nonaqueous electrolyte can be, for example, a cyclic carbonate, a linear carbonate, or a cyclic carboxylate. Examples of cyclic carbonates include propylene carbonate (PC), ethylene carbonate (EC), and fluoroethylene carbonate (FEC). Examples of linear carbonates include diethyl carbonate (DEC), ethyl methyl carbonate (EMC), and dimethyl carbonate (DMC). Examples of cyclic carboxylates include γ-butyrolactone (GBL) and γ-valerolactone (GVL). Examples of linear carboxylates include methyl propionate (MP) fluoromethyl propionate (FMP). Nonaqueous solvents can be used alone, and a combination of two or more nonaqueous solvents can also be used.

### [Separator]

The separator is an ion-permeable and insulating porous sheet. Specific examples of porous sheets include microporous thin film, woven fabric, and nonwoven fabric. The separator is preferably made of a polyolefin, such as polyethylene or polypropylene.

### EXAMPLES

The following describes the present invention in more detail by providing some examples. However, the present invention is not limited to these examples.

### Example 1

### Experiment 1

### (Preparation of Positive Electrode)

Lithium cobalt oxide, acetylene black (HS100, Denki Kagaku Kogyo K.K.), and polyvinylidene fluoride (PVdF) were weighed out and mixed to a ratio by mass of 95.0:2.5:2.5, and N-methyl-2-pyrrolidone (NMP) as a dispersion medium was added. Positive electrode slurry was prepared by stirring the mixture using a mixer (T.K. HIVIS MIX, PRIMIX Corporation). This positive electrode slurry was applied to both sides of an aluminum foil as a positive electrode collector, followed by drying and rolling with a roller. In this way, a positive electrode was prepared as a positive electrode collector with a positive electrode mixture layer on each side thereof. The packing density in the positive electrode mixture layer was 3.60 g/ml.

### (Preparation of Negative Electrode)

[Covering SiO with Cellulose Material]

A predetermined amount of sodium carboxymethyl cellulose (Daicel #1380) was added to and dissolved in 1 liter of purified water. After the addition of 1.0 kg of SiO_{X} (X=1.0) with an average particle diameter (D₅₀) of 5.8 μm, the mixture was stirred and dispersed in a homogenizer for 60 minutes. The resulting liquid dispersion was dried at 100° C. using a spray dryer to give a dry powder of SiO_{X}. The dry powder was prepared in such a manner that the coverage of the surface of SiO_{X} would be 100%.

### [Measurement of the Ratio by Mass]

A mass ratio was calculated according to formula (1) below from the weight of the resulting dry SiO_{X} powder (W₁) and the weight of SiO_{X} measured after the powder was heated at 100° C. for 3 hours in air (W₂), and the result was defined as the coverage of SiO_{X}.

Coverage [% by weight]=[(W₁−W₂)/W₁]×100 (1)

The carboxymethyl cellulose coverage of SiO_{X} was 0.5% by mass.

A 95:5 mixture of a graphite powder (an average particle diameter (D₅₀) of 20 μm) and the prepared cellulose-coated SiO_{X} particles was used as the negative electrode active material. Negative electrode mixture slurry was prepared by mixing this negative electrode active material, carboxymethyl cellulose (CMC: a degree of etherification of 0.8), and styrene butadiene rubber (SBR) to a ratio by mass of 98:1.5:0.5, together with an appropriate amount of water, using a mixer. This negative electrode mixture slurry was applied to both sides of a 10-μm-thick copper foil as a negative electrode collector sheet, followed by drying and rolling. The packing density in the negative electrode active material layer was 1.60 g/ml.

### [Preparation of Nonaqueous Electrolytic Solution]

A nonaqueous electrolytic solution was prepared by adding, to a solvent mixture composed of ethylene carbonate (EC) and diethyl carbonate (DEC) mixed in a 30:70 ratio by volume, 1.2 moles/liter of lithium hexafluorophosphate (LiPF₆) and then vinylene carbonate (VC) and fluoroethylene carbonate (FEC) each in 1% by volume.

### [Assembly of Battery]

A wound electrode body was prepared by attaching a tab to each of the electrodes and winding the positive and negative electrodes into a spiral with the separator therebetween and the tabs at the outermost periphery. This electrode body was inserted into a sheathing body composed of laminated aluminum sheets. After 2 hours of drying in a vacuum at 105° C., the nonaqueous electrolytic solution was injected, and the opening of the sheathing body was sealed. In this way, battery A1 was assembled. The design capacity of battery A1 is 800 mAh.

### Experiment 2

Battery B1 was produced in the same way as battery A1 except that in the preparation of the negative electrode, untreated SiO_{X} particles (SiO_{X} particles with no cellulose coatings) were used.

### (Experiment)

Each of these batteries was stored under the conditions below and tested for the capacity retention after 300 cycles (%) according to formula (2) below. The results are summarized in Table 1.

### [Charge and Discharge Conditions]

Constant-current charging was performed at a 1.0-it (800-mA) current until the battery voltage reached 4.2 V. Constant-voltage charging was then performed at a voltage of 4.2 V until the current reading reached 0.05 it (40 mA). After a halt of 10 minutes, constant-current discharge was performed at a 1.0-it (800-mA) current until the battery voltage reached 2.75 V.

### [Formula Used to Calculate Capacity Retention at Cycle 300]

Capacity retention at cycle 300(%)=(Discharge capacity at cycle 100/Discharge capacity at cycle 1)×100 (2)

TABLE 1

| | | 300-cycle |
|---|---|---|
| | Negative electrode | capacity |
| Battery | active material | retention (%) |
| A1 | Graphite + Cellulose- | 88 |
| | coated SiO_{X} | |
| B1 | Graphite + SiO_{X} | 85 |

As is clear from Table 1, batteries in which graphite and SiO_{X} are used as negative electrode active materials improve in terms of capacity retention when the SiO_{X} particles are changed to SiO_{X} particles coated with a cellulose-containing material. When graphite and SiO_{X} with no cellulose coatings are used as negative electrode active materials, the difference in charge potential between the materials leads to selective charging and discharge at SiO_{X}, and this presumably makes the SiO_{X} particles readily deteriorate. When graphite and cellulose-coated SiO_{X} are used as negative electrode active materials, however, increased polarization of SiO_{X} due to the presence of cellulose coatings makes the charge potential of SiO_{X} closer to that of graphite. The accordingly reduced selective charging and discharge at SiO_{X} presumably led to controlled deterioration of the SiO_{X} particles.

When the negative electrode mixture layer contains CMC as a binder, there is CMC around the SiO_{X} particles even without the use of SiO_{X} particles coated with a cellulose-containing material. In this case, however, the CMC is considered to have no such effect of controlling the deterioration of the SiO_{X} particles because the amount of CMC covering the surfaces of the SiO_{X} particles is insufficient.

### Example 2

### Experiment 3

Battery A2 was produced in the same way as battery A1 except that in the preparation of the negative electrode, CMC:SBR=1.0:1.0.

### Experiment 4

Battery A3 was produced in the same way as battery A1 except that in the preparation of the negative electrode, CMC:SBR=1.5:0.5.

### Experiment 5

Battery A4 was produced in the same way as battery A1 except that in the preparation of the negative electrode, a CMC having a degree of etherification of 1.2 was used, and CMC:SBR=1.0:1.0.

### Experiment 6

Battery A5 was produced in the same way as battery A1 except that in the preparation of the negative electrode, a CMC having a degree of etherification of 1.2 was used.

### Experiment 7

Battery A6 was produced in the same way as battery A1 except that in the preparation of the negative electrode, a CMC having a degree of etherification of 1.2 was used, and CMC:SBR=1.5:0.5.

### (Experiment)

The capacity retention at cycle 600 percent swelling (%) was determined under the same conditions as in Example 1. The results are summarized in Table 2, along with results from battery A1.

TABLE 2

| | | Degree of | | 600-cycle |
|---|---|---|---|---|
| | Negative electrode | etherification | CMC/ | capacity |
| Battery | active material | of CMC | SBR | retention (%) |
| A2 | Graphite + Cellulose- | 0.8 | 1.0/1.0 | 74 |
| | coated SiO_{X} | | | |
| A1 | Graphite + Cellulose- | 0.8 | 1.2/0.8 | 81 |
| | coated SiO_{X} | | | |
| A3 | Graphite + Cellulose- | 0.8 | 1.5/0.5 | 81 |
| | coated SiO_{X} | | | |
| A4 | Graphite + Cellulose- | 1.2 | 1.0/1.0 | 80 |
| | coated SiO_{X} | | | |
| A5 | Graphite + Cellulose- | 1.2 | 1.2/0.8 | 84 |
| | coated SiO_{X} | | | |
| A6 | Graphite + Cellulose- | 1.2 | 1.5/0.5 | 84 |
| | coated SiO_{X} | | | |

When batteries A1 to A3 are compared with batteries A4 and A6, there is a trend toward improved capacity retention with increasing degree of etherification of CMC in the negative electrode mixture layer for graphite and cellulose-coated SiO_{X} used as negative electrode active materials.

When graphite and cellulose-coated SiO_{X} are used as negative electrode active materials, CMC in the negative electrode mixture layer is more likely to be adsorbed onto the cellulose-coated SiO_{X} with increasing degree of etherification. It appears that the resulting improved adhesion and electrode plate flexibility led to controlled destruction of the electrode plate structure associated with charging and discharge.

The mass of the thickener in the negative electrode mixture layer is preferably greater than that of the binder. When the thickener is more abundant than the binder, pseudo-coatings are likely to be formed on the surfaces of the graphite particles and the cellulose-coated SiO_{X}. Such pseudo-coatings presumably prevented the electrolytic solution from decomposing by reacting with the active materials.

### REFERENCE SIGNS LIST

10 Negative electrode
11 Negative electrode collector
12 Negative electrode mixture layer
13, 13a, 13b Negative electrode active material

1. A negative electrode for a nonaqueous electrolyte secondary battery, the negative electrode comprising a negative electrode mixture layer on a negative electrode collector, wherein:
the negative electrode mixture layer contains SiO_{X} (0.5≦X≦1.5) particles and graphite particles; and
the SiO_{X} particles are covered with a cellulose-containing material.

2. The negative electrode according to claim 1 for a nonaqueous electrolyte secondary battery, wherein:
the negative electrode mixture layer contains a thickener and a binder; and
the thickener contains at least one of a carboxyalkyl cellulose, a hydroxyalkyl cellulose, and an alkoxycellulose each with a degree of etherification of 0.8 or more.

3. The negative electrode according to claim 2 for a nonaqueous electrolyte secondary battery, wherein a mass of the thickener is a greater than a mass of the binder.
